(19) United States
(12) Patent Application Publication
(10) Pub. No.: US 2026/0338546 A1
(43) Pub. Date: Oct. 29, 2026

(54) DEVICE AND METHOD FOR CHECKING THE FLATNESS OF A METAL SHEET

(71) Applicant: CONSTELLIUM NEUF-BRISACH, Biesheim (FR)

(72) Inventors: Mathieu HASSENFORDER, Orschwiller (FR); Céline GOLFOUSE-STEINER, Herrlisheim (FR); Hacienedja Virgile GUEI, Grenoble (FR); Denis STIEVENART, Dunkerque (FR)

(21) Appl. No.: 19/110,985

(22) PCT Filed: Aug. 28, 2023
(86) PCT No.: PCT/FR2023/051303

§ 371 Date: Mar. 12, 2025

(30) Foreign Application Priority Data
Sep. 16, 2022 (FR) FR2209373

(51) Int. Cl. G01B 11/30; G01N 21/89

(52) U.S. Cl. CPC G01B 11/306; G01N 21/8901; G01N 21/8914; G01N 2021/8908; G01N 2021/8918

(57) ABSTRACT

The invention relates to a device for checking the flatness of a moving metal sheet, which comprises a light source that homogeneously illuminates the sheet, a camera that records the distorted image of the light source formed by the sheet, and a calculation device that continuously calculates a coefficient correlated to the flatness by comparing the distorted image of the light source with the reference image of the light source. The invention also relates to a method for checking the flatness by means of the device according to the invention using a predetermined model M for analyzing the distorted image of the light source with respect to the reference image of the light source.

### TECHNICAL FIELD

The field of the invention is that of devices and methods for contactless checking of flatness of a metal sheet or strip produced in particular from aluminum or aluminum alloy.

### PRIOR ART

A metal sheet may have flatness defects, such as non-developable defects (e.g. long edges, long centers or pockets etc.) and developable defects (e.g. curve, curl and twist defects etc.). Flatness forms part of the many requirements that the users of sheets mention in their specification.

The patent EP1055905 discloses a method that consists in using at least two radiation sources and a certain number of detectors to detect the inspection values from a certain number of inspection points disposed at intervals in a direction transverse to the direction of the movable sheet (2). The inspection points are detected by at least two detectors that each detect the radiation at various angles and evaluate the contours of the sheet. The patent also relates to a device for determining the flatness of a sheet of material and the use of a device for determining the flatness of a sheet of material.

The patent U.S. Pat. No. 6,480,802 discloses a method for determining the flatness of a sheet of material and a device for implementing the method. The method and the device solve the technical problem of calculating the elongation of the sheet from the values of the contour of the sheet and from the determination of the flatness of the sheet of material. The method consists in calculating, from changes in slope values measured at a plurality of inspection points, the wavelength and the phase of these changes. From there the position of at least one extremum is calculated, at which the slope values measured have only a transverse component. The slopes are added to calculate a contour, from which the amplitude is calculated. The elongation of the sheet as a check on the flatness of the sheet of material is then determined from the wavelength and from the amplitude.

The patent EP3487642 relates to a method and a device for checking the flatness of the transported sheet material, including the following steps: moving the sheet material through a sheet machining device, wherein a tensile force of at least 10 N/mm² is applied to the sheet material; generating at least one projection pattern in the form of a projection grille on the surface of the sheet material by means of an optical system producing a projection, said projection pattern being projected onto the surface of the sheet material from a position that is offset laterally with respect to the central plane of the sheet material, so that a projection angle formed between the surface of the sheet material and a projection beam is between 1° and 45°; and the detection of the projection pattern by means of a camera, said camera being disposed on a transverse plane above the material of the sheet when it is seen in the direction of the movement.

The patent EP2910893 discloses a method for determining variations in flatness during the processing of a material in the form of a sheet, in particular in the hot rolling of a thin sheet, wherein a ToF camera extending transversely to the direction of the movement of the sheet zone of material in shape and by means of an evaluation unit, is connected to the ToF camera, a difference in flatness can be determined.

The patent EP0864847 discloses a method consisting in evaluating a line pattern directed onto the surface of the metal sheet by a projector. A CCD camera is used for directly examining the line pattern. The image of the pattern supplied by the camera can be compared with a reference pattern. The measured values supplied in this way can be used to adjust the production path of the metal sheet.

The patent EP1899086 discloses a method for manufacturing a metal sheet wherein the metal sheet is guided over a certain number of rollers under such a sheet force, and is moved in a transport direction, that it is largely flat at least between two rollers. In order to be able to inspect the sheet in a simple and unencumbered manner, the invention provides the internal tensile forces that act in the metal sheet, which is largely flat under the tensile force between at least two rollers to be made optically visible and for the tensile forces or the differences in tensile force that are determined in this way to be used during the manufacture of the metal sheet. Furthermore, the invention relates to an apparatus for manufacturing a metal sheet.

The application EP1570236 discloses an operation and a method for detecting torsion in an object such as pieces of wood transported on an apparatus and a method for detecting torsion in an object such as pieces of wood transported on a conveyor to use a contactless scanning technique according to which a pair of transverse scanning line beams is directed onto a surface of the article in spaced-apart relationship, and successive scannings of pairs simultaneously scanned of transverse zones spaced apart on the article are made successively while the article is transported, to generate profile data characterizing the position of each transverse zone in a reference system. The profile data characterizing the respective positions of the two transverse zones are compared with each other to generate data indicating partial torsion associated with each acquisition, followed by an adding of the data indicative of partial torsion associated with all the acquisitions to obtain an indication of the torsion in the relevant part of the article.

The patent EP2931447 discloses measurement of flatness and measurement of residual stresses in a flat metal product. One problem dealt with by the invention is that of increasing the precision and reliability of the existing apparatus for measuring flatness and/or of the methods. This problem is solved by a method for measuring the flatness of a flat metal product that includes the following method steps:—curving the flat product in a curving device so that a planar flat product would form an arc with a target bending radius r0 after bending;—measuring the contour, in particular real bending radii, in the region of the arc of the flat product folded at several positions (y) in the direction of the width of the flat product; and -determining the flatness of the flat product by taking account of the measured contour of the folded flat product.

The application EP2265895 discloses a structured system of light sensors for measuring the contour of a surface comprises a system of imaging lenses, an image capture device, a first set of mirrors of the micro-electromechanical system (MEMS) and a control module. The imaging lens system concentrates the light reflected from the surface, wherein the imaging lens system has a corresponding lens plane. The image capture device captures the focused light and generates data corresponding to the captured light, wherein the image capture device has a corresponding image plane that is not parallel to the plane of the lens. The first set of MEMS mirrors directs the focused light to the image capture device. The control module receives the data, determines the quality of focusing of the captured light according to the data received and controls the first set of MEMS mirrors according to the focusing quality to maintain a Scheimpflug inclination condition between the lens and the plane of the image.

The patent EP0397672 discloses a method and system for high-speed and high-resolution 3D imaging of an object at a vision station, including an anamorphic magnification and a system of field lenses, to transmit the light reflected from the object to a position detector with a small surface having a position detection direction. Preferably, an acousto-optical deflector not having any moving parts with the associated lens elements scans a modulated laser light beam in a scanning direction through the object to be inspected to produce a flat-field telecentric scanning. The deflector has a feedback loop to allow uniform illumination of the object (i.e. flat-field correction). The light diffused by the object is captured by a telecentric reception lens.

The application WO2012/037186 discloses a contactless detection system is supplied by the acquisition of three-dimensional contour information on an object. The system is composed of a light-source subsystem operable to scan a light point in an illumination zone; a first imaging device provided with a vision field disposed so as to intersect with the illumination zone and usable for capturing image data; and a second imaging device having a vision field disposed to intersect the illumination zone and usable for capturing image data. A first control module is in data communication with the first imaging device to determine the contour information of an object in the field of exploration of the first imaging device and to report the contour information for the object in a common system of coordinates. A second control module is in data communication with the second imaging device to determine the contour information of an object in the field of vision of the second imaging device and to report the contour information for the object in the common system of coordinates. In addition, the subsystem of the light source is calibrated to indicate the position of the light spot in the common system of coordinates.

The patent U.S. Pat. No. 6,252,659 discloses a three-dimensional measuring apparatus comprises an optical system for scanning a reference beam through a target object to be measured, a light sensor that receives the light reflected by the target object, and a processor for calculating a dimensional form of the target object from the light received. An image for calculating the three-dimensional form of the target object and an image for displaying the target object are both captured by the same sensor. The displayed image is a gray-level image based on a centroid calculated from several data samples taken for each pixel of the image during the acquisition of the target.

The patent application EP1346204 discloses a device for the automatic surface inspection of an uncoiled strip to detect surface defects, comprising at least one camera the optical axis which is directed towards the surface to be inspected and forming on said surface a transverse line of sight and at least one illumination system the incident rays of which are directed towards the transverse line of sight and distributed over the entire length of said line. At each point of the transverse line of sight, the observation direction of the camera forms, with the specular Ray reflected at said point, a constant angle.

The patent application U.S. Pat. No. 3,590,258 discloses an apparatus for checking the form of a rolled product moving in a longitudinal direction, comprising means for projecting a linear image onto the surface of the rolled product in the transverse direction thereof, means for detecting the longitudinal deviation of a part of said linear image at least at said central part and of the end of said image, and oil-pressure means for regulating the pressure actions on the central part and the output of said detection means.

The application DE102014104338 discloses a simple and rapid method for determining small surface deformations on reflective or bright movable pieces. For this purpose, a method is provided for detecting the surface deformations on reflecting objects, wherein a light source is provided that has at least one light-darkness linear transition, wherein the surface of the object is illuminated by the light source at an oblique angle. The light from the light source reflected by the surface of the object and the line of the light-darkness transition are detected by means of an image detector, while the object is moved with respect to the arrangement composed of the image detector and the light source. The direction of the movement of the object is transverse to the longitudinal direction of the light-darkness transition. A surface deformation on the surface of the object is detected on the basis of a difference with respect to the linear trajectory of the light-darkness transition imaged with the imaging detector.

### DESCRIPTION OF THE INVENTION

The objective of the invention is to propose a device and a method for contactless checking of flatness of a sheet or strip that is simpler than the prior art, compatible with the demanding environment of a heavy-industry metallurgy production shop.

The invention is a device for checking flatness of a metal sheet or strip 1 in movement in a direction X, comprising:
a) A light source 2 illuminating a field of observation 4 of the sheet or strip 1 substantially homogeneously,
b) A camera 3, which is a 2D digital camera and is disposed so as to record, in the field of observation 4, at least one photograph of a deformed image 22 of the light source 2 formed by the sheet or strip 1,
c) A computing device for comparing at least one photograph of the deformed image 22 of the light source 2 with a photograph of a reference image 20 of the light source 2 and for continuously computing at least one coefficient correlated with the flatness of the sheet or strip 1.

The invention is also a sheet or strip production machine comprising the device according to the invention.

The invention is also a method for checking flatness with a device according to the invention comprising the successive steps:
a) The camera 3 transmits a photograph of the deformed image 22 of the light source 2 to the computing device,
b) a predetermined model M implemented in the computing device determines a photograph of the reference image 20 of the light source 2
c) the predetermined model M compares the photograph of the deformed image 22 of the light source 2 with the photograph of the reference image 20 of the light source 2,
d) the predetermined model M computes at least one coefficient correlated with the flatness of the sheet or strip 1.

### BRIEF DESCRIPTION OF THE DRAWINGS

Other aspects, aims, advantages and features of the invention will appear more clearly from the reading of the following detailed description of preferred embodiments thereof, given by way of non-limitative example and made with reference to the accompanying drawings, on which:

FIG. 1 is a schematic view of the device seen from above.

FIG. 2 is a schematic view of the side of the device in the case of a perfectly flat sheet or strip.

FIG. 3 is a schematic side view of the device showing the movement of the image of the light source when the sheet or strip has a flatness defect.

FIG. 4 is a schematic view from the location of the camera showing the image of the light source with a perfectly flat sheet or strip and with a sheet with a flatness defect.

FIG. 5 shows an example of a photograph of a deformed image 22 of the light source 2 obtained with the device according to the invention.

FIG. 6 shows a photograph of the deformed image 22 of a light source obtained with a device that is not according to the invention.

FIG. 7 shows an example of an analysis of the photograph of the deformed image 22 of the light source 2.

FIG. 8 shows another example of an analysis of the photograph of the deformed image 22 of the light source 2.

FIG. 9 shows a counterexample of the device according to the invention.

FIG. 10 shows a schematic example of a production line comprising the device according to the invention.

FIG. 11 shows a schematic example of a production line comprising the device according to the invention.

### DETAILED DESCRIPTION OF PARTICULAR EMBODIMENTS

In the figures and in the remainder of the description, the same references represent identical or similar elements. In addition, the various elements are not plotted to scale so as to favor clarity of the figures. Moreover, the different embodiments and variants are not exclusive of one another and could be combined together. Unless indicated to the contrary, the terms “substantially”, “approximately”, and “of the order of” mean to within 10%, and preferably to within 5%. Moreover, the terms “lying between . . . and . . . ” and equivalent mean that the bounds are inclusive, unless mentioned to the contrary.

The sheet or strip 1 is a metal sheet or strip, preferentially made from aluminum or from aluminum alloy. This is because sheets or strips made from aluminum or from aluminum alloy have a light-reflecting capacity visible to the human eye. The terms and definitions of EN 12258-1 (2012) are applicable. The difference between the terms sheet and strip is defined by note 3 of paragraph 2.6.1 of EN 12258-1 (2012), in this case: in Europe, the term “sheet” is used only for rolled products supplied in a straight length, for sheets in a coil the term “strip” is used. A sheet is therefore a flat product. A strip can be transformed into a sheet by any operation of cropping or cutting to length known to a person skilled in the art. However, the term strip is extended to rolled products the thickness of which is less than 0.20 mm. The standards EN 485-3 (2003) and EN 485-4 (1994) define the shape tolerances for sheets, strips and thick sheets made from aluminum or from aluminum alloy. These standards describe in particular certain flatness defects well known to a person skilled in the art. Metallurgical states are defined by EN 515 (2017).

The sheet or strip 1 is in movement in the direction of movement X. The sheet of strip therefore has a translation movement. The movement may be relative, and the device may therefore be moved with respect to the sheet. In the case of a sheet, the preferential direction of movement is in either the long direction L of rolling, or the long cross-direction TL, this corresponding to the large side of the sheet being preferred for reducing the size of the machine. The directions Land TL are not shown. In the case of a strip, this is uncoiled and the direction of the movement of the strip is the long direction or rolling direction. The perpendicular direction Y is the direction perpendicular to the direction of the movement X in the plane of the sheet or strip 1.

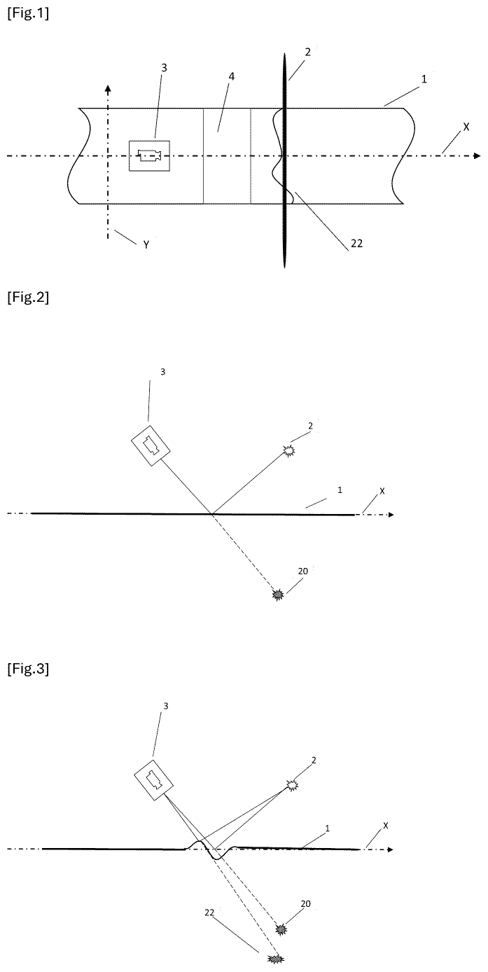

FIG. 1 shows the sheet or strip 1 and the device seen from above. The direction X is the direction of movement of the sheet or strip 1 and the direction Y is the direction perpendicular to the direction X in the plane of the sheet or strip 1. As it is a case of a plan view, neither the reference image 20 of the light source 2 nor the deformed image 22 of the light source 2 are located in the field of observation 4. Because of the laws of geometric optics, these images are located under the light source 2. The reference image 20 of the light source 2 is masked by the presence of the light source 2. On the other hand, the deformed image 22 of the light source 2 can be visible in plan view according to the deformation of the sheet or strip 1.

FIGS. 2 and 3 show a side view of the device. FIG. 2 corresponds to a perfectly flat sheet or strip 1. The reference image 20 of the light source 2 is symmetrical with the light source 2 with respect to the perfectly flat sheet or strip because of the laws of geometric optics. FIG. 3 shows a flatness defect of the sheet of strip 1 in the process of passing through the field of observation 4 (not shown). Because of the laws of geometric optics, the image of the light source 2 moves and deforms and becomes the deformed image 22 of the light source 2. This movement and deformation are dependent on the advancement of the flatness defect of the sheet of strip 1.

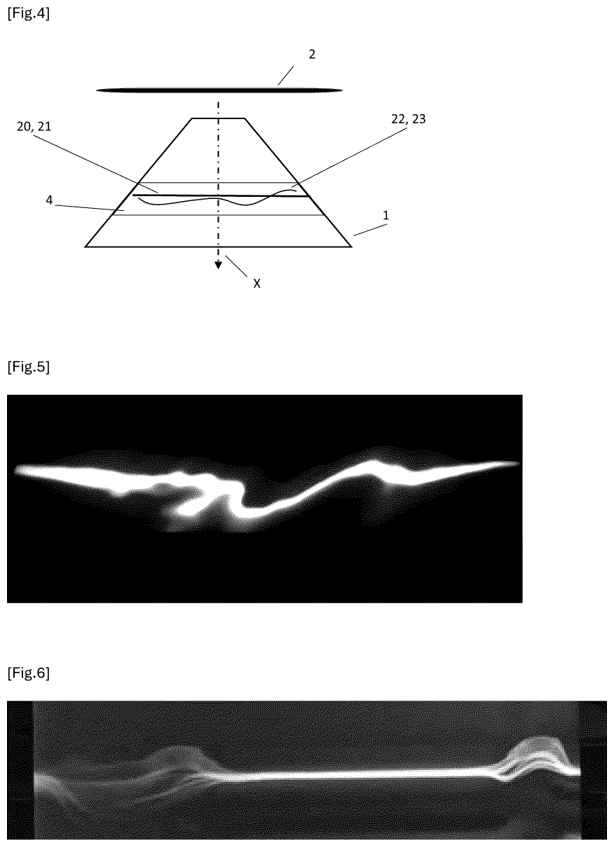

FIG. 4 shows the previous device with the camera 3 as the observation point. The camera 3 sees and can photograph the image of the light source 2 both as reference 20 and deformed form 22 in the field of observation 4. FIG. 9 shows the device with an unsuitable observation point for the camera 3 since this observation point is too close to the light source 2 since the photograph of the deformed image 22 of the light source 2 is not located in the field of observation 4. Analysis can therefore not take place correctly. Therefore, in arranging the camera 3, the light source 2 and the field of observation, account must be taken of the laws of geometric optics known to a person skilled in the art.

The light source 2 illuminates a field of observation 4 on the sheet or strip 1 substantially homogeneously. The field of observation 4 is fixed with respect to the light source 2 and to the camera 3. The field of observation 4 is a predetermined part of the plane that corresponds to the upper face of the sheet of strip 1 if it is perfectly flat. Preferably, the illumination of the field of observation 4 does not vary by more than 10%, more preferably 5%, more preferably 2% with respect to the mean value of the illumination (light flow received per unit surface) of the field of observation 4. Heterogeneous illumination degrades the analysis of the photograph of the deformed image 22 of the light source 2, which degrades the results of the calculations of the computing device. The illumination is the quantity of light per unit surface. The light source 2 therefore does not project a particular pattern onto the sheet.

The field of observation 4 is selected so that the photograph of the deformed image 22 of the light source 2 and the photography of the reference image 20 of the light source 2 are in the field of observation 4 for the camera 3. The field of observation 4 is therefore predetermined according to the flatness defects of the sheet or strip 1, which a person skilled in the art knows by experience.

Preferentially, the field of observation 4 is a rectangle the small sides of which are parallel to the edges of the sheet or strip 1. Preferentially, two of the edges of said rectangle correspond to the edges of the sheet or strip. Preferentially, the ratio between the small side of said rectangle and the width of the sheet or strip is greater than 30%. According to the experience of the inventors, this ratio of 30% is sufficient to observe or check the usual flatness defects of the sheet or strip 1 made from aluminum or from aluminum alloy. If said ratio is less than 30%, a photograph of the deformed image 22 of the light source 22 may no longer be recorded completely by the camera 3, which will degrade the analysis of the photograph of the deformed image 22 of the light source 2, which will therefore degrade the results of the calculations of the computing device.

The light source preferentially emits a light visible to a human being. A visible light is advantageous since it makes it possible to use numerous commercially available sources or cameras. The light source 2 is not a coherent light source such as the one produced by a laser, as a non-limitative example. Preferentially, the color of the light source is white so as to have the best contrast on the photographs. Preferentially, the light source 2 consists of light-emitting diodes (LEDs). LEDs are less expensive than a laser. LEDs are also less dangerous for the eyes than a laser. LEDs do not cause an irisation phenomenon. A light source such as a fluorescent tube causes irisation that impairs the quality of the image for checking flatness. The scintillation frequency of the light source 2 is sufficiently higher than the acquisition frequency of the camera 3 to avoid scintillation of the photograph of the deformed image 22 of the light source 2 recorded by the camera 3. Because of the high scintillation frequency of LEDs, LEDs are preferentially used as light source 2 to check the flatness of a strip in rapid movement, as on a guillotine for finishing an aluminum strip, the speed of which can typically be as much as 900 m/min. LEDs make it possible to obtain a very sharp photograph of the deformed image 22 of the light source, as shown by FIG. 5. FIG. 6 shows a photograph of the deformed image of a fluorescent tube the quantity of which is insufficient because of the scintillation. Preferentially, the density of the LEDs of the light source 2 is sufficient for the light source 2 to appear continuous on the photograph of the reference image 20 or on the photograph of the deformed image 22 of the light source 2. This continuity facilitates analysis of the image by the predetermined model M as a continuous object, in particular a line.

Preferably, the light source 2 is sufficiently extensive in the perpendicular direction Y for the images of the ends of the light source 2 in the perpendicular direction Y not to be photographed in the field of observation 4, preferably so that the images of the ends of the light source 2 in the perpendicular direction Y are not photographed by the camera 3. This provides a check on the flatness of the sheet or strip 1 in the field of observation 4, preferentially in the whole field of observation that the camera 3 can photograph.

Preferentially, the light source 2 is substantially linear in form and straight. More preferentially, the light source 2 is substantially perpendicular to the direction of the movement X. The light source 2 is substantially linear in form if the photograph of the reference image 20 of the light source 2 if a line exists such that any point on the photograph of the reference image 20 of the light source 2 is at a distance less than 10%, preferentially 5%, of the width of the sheet or strip 1 at at least one point on said line. The light source 2 is substantially straight in form if the length of the large side of the smallest rectangle, small in the sense of the smallest possible surface area, which contains the photograph of the reference image 20 of the light source 2 is at least 10 times longer than the small side of said rectangle. The substantially linear and straight form of the light source 2 makes it possible to implement a preferred embodiment of the method according to the invention described below. This orientation and form make it possible to reduce the length in the direction of the movement X of the device for checking flatness. Preferentially, the light source 2 is in a plane substantially parallel to the plane of the sheet or strip 1. The plane of the sheet or strip 1 is the plane if the sheet or strip 1 were perfectly flat. If referencing means, as described below, are used, they define such a plane. This makes it possible to reduce the difference in length between the longest and shortest optical paths between the light source 2 and the camera 3 reflected by the sheet or strip 1 in accordance with the laws of geometric optics. This reduces the distortion of the photograph of the deformed image 22 of the light source 2 and improves the analysis of the photograph of the deformed image 22 of the light source 2.

Preferentially, there is no other light source that directly or indirectly could create another image that could be photographed by the camera 3 to avoid degrading the quality of the photographs for analysis thereof. The device is therefore advantageously protected from other light sources with guards or covers while allowing movement of the sheet or strip 1. Preferentially, the camera 3 and the light source 2 are disposed so that the light source 2 does not appear on the photographs transmitted by the camera 3 to avoid any confusion with the deformed image 22 of the light source 2 that could interfere with the calculation of at least one coefficient correlated with flatness.

The camera 3 is a 2D digital camera, simpler than a 3D camera. The camera 3 is not a ToF (time-of-flight) camera, which is an expensive item of equipment. The camera 3 is disposed so as to record at least one photograph of the deformed image 22 of the light source 2 formed by the metal sheet 1 in the field of observation 4. If the deformed image 22 of the light source 2 is not formed in the field of observation 4 seen by the camera 3, this will degrade the quality of analysis of the photograph. This degradation is caused by a deformed image 22 of the light source 2 photographed by the camera 3 incompletely in the field of observation 4.

Preferentially, the camera 3 records photographs with a predetermined period. The recording period is predetermined by the speed of movement of the sheet or strip 1 and by the flatness defects that a person skilled in the art knows by experience. The predetermined period must be sufficient to correctly sample the flatness defects having regard to the speed of movement of the sheet or strip 1. The selection of the camera 3 must be adapted according to the size of the defects to be checked and the speed of movement of the sheet or strip 1. The resolution of the camera 3 must be sufficient to correctly sample the field of observation 4 and to observe the flatness defects sought.

Preferentially, the camera 3 is substantially centered with respect to the field of observation 4. The position of the camera 3 is centered if this position corresponds to the minimum of the difference in length between the longest and shortest optical path between the light source 2 and the camera 3 reflected by the sheet compared with the other positions of the camera 3 obtained by a translation in the perpendicular direction Y. If the field of observation 4 is a rectangle the small sides of which are parallel to the edges of the sheet or strip 1, the camera 3 is substantially disposed in a plane perpendicular to the field of observation 4 and containing the right bisector of the large side of the field of observation 4. This position reduces the distortion of the photograph of the deformed image 22 of the light source 2 and improves the analysis of the photograph of the deformed image 22 of the light source 2. The camera 3 being disposed so as to record the photograph of the deformed image 22 of the light source 2, it is not focused to record photographs of the surface of the sheet or strip 1. The camera 3 cannot therefore photograph and analyze surface defects or patterns projected onto the surface of the sheet or strip 1.

The relative positions of the camera 3, of the light source 2 and of the sheet or strip 1 are a compromise. The minimum optical path is the shortest path of the light from the light source 2 to the camera 3 reflected by the sheet or strip 1 in accordance with the laws of geometric optics. The longer the minimum optical path, the more sensitive the device will be for checking a flatness defect. On the other hand, the longer the minimum optical path, the more necessary it will be to increase the sensitivity and resolution of the camera 3 and/or the light power of the light source 2. Preferentially, the camera 3 and the light source 2 are at the same height to facilitate the design of the device. Preferentially, the camera 3 and the light source 2 are at least at a width of the strip or sheet 1 above the sheet or strip 1. Such an arrangement makes it possible to limit the depth of field of the camera 3 so that the photograph of the deformed image 22 of the light source 2 is sharp between the closest and furthest point on the deformed image 22 of the light source 2 with the camera 3. This makes it possible to avoid the use of a camera 3 with a complex lens. Preferentially, in the case of a strip tensioned between two referencing means described below, the camera 3 is substantially above one of the referencing means, and the light source 2 is substantially above the other referencing means. This arrangement makes it possible best to exploit the surface of the device without interfering with other equipment. In one embodiment, the camera 3 and the light source 2 are at at least 2 m above the strip to facilitate access to the interior of the device when the device is being maintained in an industrial context.

Preferentially, the device according to the invention comprises referencing means that are disposed so as to ensure that the sheet or strip 1 is positioned to avoid movements of the sheet 1 in directions other than the direction of the movement X. These movements in other directions are liable to cause movements of the deformed image 22 of the light source 2 and therefore to degrade the quality of the coefficient correlated with the flatness of the strip or sheet 1. These referencing means are, as a non-limitative example, a positioning surface or rollers in the case of a sheet. The means for referencing a strip can, as a non-limitative example, be rollers, gripping rollers, S blocks, pay-off machines or winders, which are well known to a person skilled in the art of strip-production machines. Preferentially, the field of observation 4 for a strip is disposed between two referencing means and without any other referencing means between the two said referencing means. Preferentially, these two referencing means are spaced apart by at least the width of the strip 1 so that the flatness defects are not attenuated by the proximity of the two referencing means and to ensure a good check on flatness. Preferentially, the zone of the strip 1 on which the light rays emitted by the light source 2 towards the camera 3 are reflected is substantially centered between the two referencing means so that the flatness defects are not attenuated by the proximity of the two referencing means and to ensure a good check on flatness. The referencing means tension the strip. The strip must not be too tensioned so as not to degrade the quality of the coefficient correlated with flatness, as explained below.

The device according to the invention preferentially forms part of a sheet or strip production machine. Preferentially, these machines are finishing or completion machines such as, as a non-limitative example, shears, saws, flatteners, varnishing machines, degreasers or continuous heat treatment furnaces. The environment and the tension level of the sheet during rolling makes it more difficult to install the device according to the invention on a rolling mill.

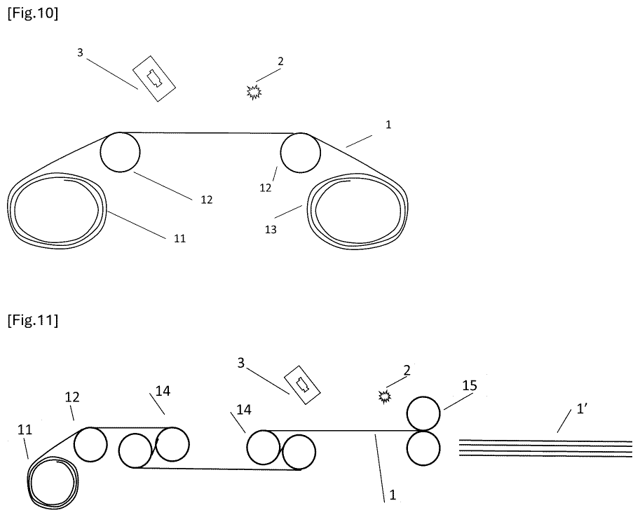

FIG. 10 shows a non-limitative example of a strip-production machine 1 comprising a pay-off machine 11, two rollers 12 and a winder 13, which are means for referencing the strip 1 and are spaced apart by at least the width of the strip. The machine in FIG. 10 can also have other functions that are not shown, such as those of the aforementioned machines. FIG. 11 shows a non-limitative example of a strip or sheet production machine. The strip is unwound on a pay-off machine 11. The strip next passes through a flattener under tension framed by two S blocks 14, the flattening cage not being shown but known to a person skilled in the art. The strip 1 next passes through the device according to the invention and then through gripper rollers 15. The device according to the invention is positioned in the space between the two referencing means, which are the S block 14 and the gripper rollers 15. Then the strip 1 is cut into sheets 1′, the cutting and stacking device, known to a person skilled in the art, is not shown.

When a person skilled in the art measures the various flatness characteristics of a sheet or strip, he places the sheet or strip, in the case of a strip in general a sample, on an inspection table to make the flatness measurements with a rule. Flatness defects such as long edges or lines of pockets result from a difference in length in the width of the sheet or strip 1. The tensioned strip elongates, which reduces the difference in length and modifies the flatness of the moving strip 1. If the strip is tensioned by excessively strong traction, this may cancel out the difference in length and make it impossible to check flatness. Excessively strong traction may also definitively deform the strip if the traction exceeds the elastic limit of the strip. The level of traction applied to the strip is predetermined by the various items of equipment of the machine on which the device according to the invention is used. For example, if one of the referencing means comprises a winder that winds the strip in a coil, the traction must be sufficient to ensure cohesion of the coil and to avoid surface defects by rubbing the strip on itself. The traction must not be too strong to avoid collapse of the strip wound in a coil on its inside diameter. Preferentially, the traction is at least 10 MPa, preferentially 15 MPa. Preferentially, the traction is no more than 30 MPa.

The reference image 20 of the light source 2 is the image of the light source 2 for a perfectly flat sheet, i.e. the reference image 20 is symmetrical, with respect to the sheet strip 1, with the light source in accordance with the laws of geometric optics. When a flatness defect in the moving sheet or strip 1 passes through the field of observation 4, the reference image 20 of the light source 2 moves and deforms in accordance with the laws of geometric optics to become the deformed image 22 of the light source 2. For a person skilled in the art of geometric optics, the light source 2 and the reference image 20 the light source 2 are conjugated by the plane of the sheet or strip 1, which is the plane if the sheet or strip 1 were perfectly flat. For a person skilled in the art of geometric optics, the light source 2 and the deformed image 22 of the light source 2 are conjugated by the sheet or strip 1. The invention therefore consists in analyzing the geometric aberration caused by the sheet or strip 1, which behaves as a deforming mirror. When the curvature of the deformation is small, the deformed image 22 of the light source 2 moves while deforming very little. Because of the laws of geometric optics, there may be duplications. FIG. 5 shows an example where the deformed image of a linear straight light source is locally duplicated with a fork or branch. When the curvature of the deformation is large, because of the laws of geometric optics there is an effect of enlarging the deformed image 22 of the light source 2. The result is a deformed image 22 of the light source 2 that enlarges and is less bright. The movement and deformation of the image of the light source 2 are therefore a consequence of the flatness defects in the sheet or strip 1 and are also a consequence of the movements of the sheet or strip 1 and of its flatness defects. The laws of geometric optics have been known for a long time but solving them for numerous flatness defects in a sheet is complex.

The method for checking the sheet or strip in movement includes the following steps
a) The camera transmits a photograph of the deformed image 22 of the light source 2 to the computing device,
b) a predetermined model M implemented in the computing device determines the photograph of the reference image 20 of the light source 2,
c) the predetermined model M compares the photograph of the deformed image 22 of the light source 2 with the photograph of the reference image 20 of the light source 2,
d) the predetermined model M computes at least one coefficient correlated with the flatness of the sheet or strip 1.

The predetermined model M uses the data characteristic of the sheet or strip such as the composition of the alloy constituting it, its dimensions, its mechanical properties, its metallurgical state, its speed and the traction level of the sheet. The predetermined model M may be a database (nomograms) obtained in advance for example experimentally and/or numerically. The experimental method consists in comparing the maximum flexion or the local maximum flexions of a sheet or of a sample of the immobile strip measured on a table with the photograph of the deformed image 22 of the light source 2 and with the photograph of the reference image 20 of the light source 2. The predetermined model M can also be obtained by any learning method. The predetermined model can use the image analysis tools known to a person skilled in the art, such as, as a non-limitative example, pixelization or skeletonization.

The comparison made by the predetermined model M consists in analyzing the geometry of the photograph of the deformed image 22 of the deformed light source 2. As a non-limitative example, the deformation of a straight line may be a curve. As a non-limitative example, the deformation of a shape such as a circle may be an ellipse.

The photograph may also be analyzed by a predetermined gray-level model for each pixel of the photograph transmitted by the camera 3. Gray-level analyzing is advantageous since this makes it possible to identify flatness defects that cannot be defined geometrically. For example, if the light source is a straight line, if the image deformed by the flatness defect in the sheet of strip is an arc of a parabola located in the plane defined by the camera 3 and the reference image 20 of the light source 2, then the deformed image 22 of the light source 2 is photographed by the camera 3 only as a line that does not seem to be deformed geometrically. However, as each point on the deformed image 22 of the light source 2 has moved with respect to the reference image 20 of the light source 2 by approaching or moving away from the camera 3, the pixels of the photograph transmitted by the camera 3 will be illuminated to a greater or lesser extent and will appear more or less gray. Gray-level analysis of the image makes it possible to check flatness defects in the strip or sheet 1. The term gray does not limit this method to an analysis of a photograph obtained with a white light. The term gray must be interpreted as the variation in the illumination of the pixels of the camera 3.

The maximum flexion of a sheet is defined by EN 485-3 or EN485-4. Having regard to said standards, the maximum flexion is correlated with the flatness. The local maximum flexions are defined by dividing the sheet or strip into a plurality of sectors substantially parallel to the direction of the movement X. The local maximum flexion on a sector is the maximum of the flexion over said sector. In a similar manner to local flatness, local flatness for each sector can also be calculated. Having regard to said standards, the maximum flexion is correlated with the flatness of the sheet or strip 1 and the local maximum flexions are correlated with the local flatnesses of the sheet or strip 1. Following the local flatness of the sheet or strip is advantageous since this makes it possible to analyze the flatness defects of the sheet or strip 1 more finely.

In a preferred embodiment, the light source 2 is substantially linear and straight in form. The predetermined model M will therefore analyze the photograph of the deformed image 22 of the light source 2 as a deformed line 23 by the image analysis methods known to a person skilled in the art, such as, as a non-limitative example, pixelization or skeletonization. The predetermined model M will therefore analyze the photograph of the deformed image 20 of the light source 2 as a reference line 21 by the image analysis methods known to a person skilled in the art, such as, as a non-limitative example, pixelization or skeletonization. The deformed line 23 may be duplicated because of the laws of geometric optics, as the example in FIG. 5 shows. In this preferred embodiment, steps b to d of the method according to the invention comprise the following successive steps:
i) the predetermined model M analyzes the photograph of the deformed image 22 of the light source 2 as a deformed line 23,
ii) a reference line 21 is preferentially estimated by the linear regression of a deformed line 23,
iii) a distance to the reference line 21 is obtained by calculating the mean of the Euclidean distance of each point on the deformed line 23 to the reference line 21, and/or the following successive steps:
iv) the predetermined model M analyzes the photograph of the deformed image 22 of the light source 2 as a deformed line 23, iv) the deformed line 23 is segmented into a predetermined plurality of elements,
v) vi) a segmented reference line 24 is calculated by the linear regression of each element of the segmented deformed line 23,
vi) vii) for at least one element of the segmented deformed line 23, a distance to the segmented reference line 24 is obtained by calculating the mean of the Euclidean distance of each point of the element of the deformed line 23 to the segmented reference line 24.

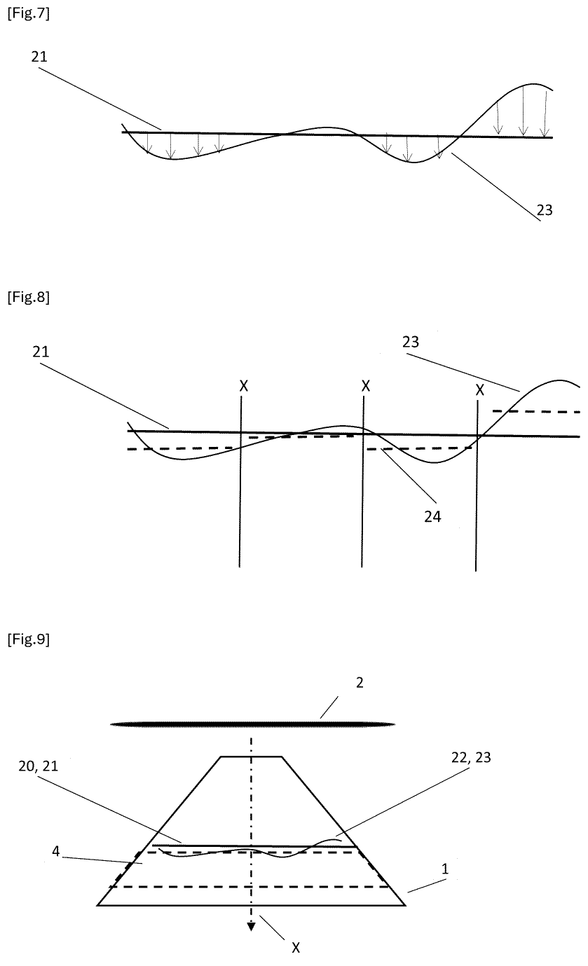

In this preferred embodiment, estimating the reference line 21 by the linear regression of the deformed line 23 is advantageous since this simplifies the determination of the reference line 21. FIG. 7 illustrates the principle of the step iii of calculating the mean of the Euclidean distance between the reference line 21 and the deformed line 23. This mean is a coefficient correlated with the flatness of the sheet or strip 1. The predetermined model M can also compute the flatness of the sheet or strip 1. It uses the data characteristic of the sheet or strip 1 such as its composition, its dimensions, its mechanical properties, its metallurgical state, its speed and the traction level of the sheet. The predetermined model M may be a database (nomograms) obtained in advance for example experimentally and/or numerically. The experimental method consists in comparing the maximum flexion or the local maximum flexions of a sheet or immobile strip 1 measured on a table with the mean of the Euclidean distance between the reference line 21 and the deformed line 23. The predetermined model M can also be obtained by any learning method.

FIG. 8 illustrates the principle of steps iv to vii. The deformed line 23 is segmented into a predetermined plurality of elements. This segmentation is predetermined according to the sheet or strip 1 and the usual defects expected through the experience of a person skilled in the art. This segmentation can be obtained by segmenting the deformed line 23 into segments of predetermined relative length. In the case where there is a fork or branch, for example the one visible in FIG. 5, this fork or branch is treated as a turn on a curve to determine the relative lengths of the segments of the segmented deformed line 23. Another equivalent method consists in using the reference line 21 and segmenting it into a predetermined plurality of segments. Then the deformed line 23 is segmented into a plurality of elements by the projection in the direction of the movement X of the line of segmented reference line 21. Then a segmented reference line 24 is calculated by the linear regression of each element of the segmented deformed line 23. It should be noted that the segmented reference line 24 is not necessarily continuous. On FIG. 8 the direction of the movement X is shown several times to show the segmentation of the reference line 21 that is projected onto the deformed line 23 to obtain the segmented deformed line 23. The mean of the Euclidean distance of all the points of a segment of the segmented deformed line 23 to the segmented reference line 24 is a coefficient correlated with the local flatness of the sheet or strip 1. These methods for computing the segmented reference line 24 are advantageous since they make it possible to focus on the local flatness defect. In a similar manner to the above, the predetermined model M can also compute the local flatnesses of the sheet or strip 1.

Preferably, the camera 3 transmits a photograph of the deformed image 22 of the light source 2 to the computing device according to a predetermined period, to check the flatness over the length of the sheet or strip 1. Preferably, at least one coefficient correlated with the flatness of the sheet or strip 1 is a mean on a predetermined plurality of sliding photographs of the coefficients correlated with the flatness calculated for each photograph. Calculating at least one coefficient correlated with the flatness on a mean on a plurality of sliding images consists in computing the mean of the at least one coefficient correlated with the flatness on each of the plurality of photographs of the deformed image 22 of the light source 2 previously transmitted by the camera 3. Calculating these means is advantageous since this makes it possible to filter the noise related to the predetermined period of transmission by the camera 3.

In a preferred embodiment, the method according to the invention furthermore includes step e: the predetermined model M compares the photograph of the deformed image 22 of the light source 2 with respect to the photographs of the deformed images 22 of the light sources 2 that were previously transmitted by the camera 3. This comparison is advantageous since it makes it possible to identify repetitive flatness defects on the sheet or strip 1. Two flatness defects are repetitive if the photographs of their deformed image 22 of the light source 2 can be superimposed with a margin of error of less than 5%, preferably 2% of the width of the sheet or strip 1. Identifying the repetitive defects in the length of the sheet or strip is advantageous in particular for rolled products since this makes it possible to effectively seek the rolling-mill rollers or the mill rolls or the machines that may be the cause of said defect. Having regard to the length of a strip, this is much more advantageous on a strip the length of which may be greater than 100 m whereas the longest known sheets, sheets for passenger aircraft wings, are not more than 36 m in length. Advantageously, this comparison and identification can be done with the deformed line.

The advantage of the device and method is to allow real-time checking of the flatness of the sheet or strip 1 without stopping production to measure the flatness on a table, which furthermore makes it possible to avoid cutting the strip to take a sample to bring it to a table. The advantage of the device and method is that they can be installed in a heavy-industry metallurgical-product workshop the temperature and humidity of which are not regulated and depend on the climate and the atmosphere of which may contain dust. The device and method do not require operating conditions that can be obtained only in a laboratory. The other advantage of the device and method is being simpler than the prior art, in particular since the predetermined model M can be used by the ibaVision and Halcon libraries. The device uses less hardware or less expensive hardware.

1) A device for checking the flatness of a metal sheet or strip moving in a direction X, comprising:
a) A light source illuminating a field of observation of the sheet or strip substantially homogeneously,
b) A camera, which is a 2D digital camera and is disposed so as to record, in the field of observation, at least one photograph of a deformed image of the light source formed by the sheet or strip,
c) A computing device for comparing at least one photograph of the deformed image of the light source with a photograph of a reference image of the light source and for continuously computing at least one coefficient correlated with the flatness of the sheet or strip .

2) A flatness-checking device according to claim 1, wherein the light source is substantially linear and straight in form, optionally substantially perpendicular to the direction of the movement X.

3) The flatness-checking device according to claim 1, wherein the light source is in a plane substantially parallel to the plane of the sheet or strip.

4) The device according to claim 1, wherein the light source consists of light-emitting diodes (LEDs).

5) The flatness-checking device according to claim 1, wherein the camera is substantially centered with respect to the field of observation.

6) The flatness-checking device according to claim 1, wherein the images of the ends of the light source in the perpendicular direction are not in the field of observation, and optionally in that the images of the ends of the light source in the perpendicular direction are not visible to the camera.

7) The device for checking flatness of a strip according to claim 1, wherein the device comprises referencing means that optionally are spaced apart by at least the width of the sheet or strip.

8) A sheet or strip production machine comprising the device according to claim 1.

9) A method for checking flatness with the device according to claim 1, comprising the following successive steps:
a) The camera transmits a photograph of the deformed image of the light source to the computing device,
b) a predetermined model implemented in the computing device determines the photograph of the reference image of the light source,
c) the predetermined model compares the photograph of the deformed image of the light source with the photograph of the reference image of the light source,
d) the predetermined model computes at least one coefficient correlated with the flatness of the sheet or strip.

10) The method according to claim 9 with the device the light source of which is substantially linear and straight in form, wherein steps b to d comprise the following successive steps:
i) the predetermined model analyzes the photograph of the deformed image of the light source as a deformed line,
ii) a reference line is preferentially estimated by the linear regression of a deformed line,
iii) a distance to the reference line is obtained by calculating the mean of the Euclidean distance of each point on the deformed line to the reference line, and/or the following successive steps
iv) the predetermined model analyzes the photograph of the deformed image of the light source as a deformed line,
v) the deformed line is segmented into a plurality of elements,
vi) a segmented reference line is calculated by the linear regression of each segment of the deformed line,
vii) for at least one element of the segmented deformed line, a distance to the segmented reference line is obtained by calculating the mean of the Euclidean distance of each point of the element of the deformed line to the segmented reference line.

11) The continuous flatness-checking method according claim 9, wherein the camera transmits a photograph of the deformed image of the light source to the computing device according to a predetermined period.

12) The continuous checking method according to claim 11, wherein at least one coefficient correlated with the flatness of the sheet or strip is a mean on a predetermined plurality of sliding photographs.

13) The method according to claim 11, further including the step
e) the predetermined model compares the photograph of the deformed image of the light source with respect to the photographs of the deformed images of the light sources that were previously transmitted by the camera.

14) The method according to claim 12, wherein the predetermined model identifies the repetitive flatness defects.
